(19) United States
(12) Patent Application Publication
(10) Pub. No.: US 2015/0302507 A1
(43) Pub. Date: Oct. 22, 2015

(54) SYSTEM AND METHOD FOR REMOTE SHOPPING

(71) Applicant: SUNRISE R&D HOLDINGS, LLC, Cincinnati, OH (US)

(72) Inventors: Dion B. PERKINS, Cincinnati, OH (US); Brett Bracewell BONNER, New Richmond, OH (US)

(21) Appl. No.: 14/689,577

(22) Filed: Apr. 17, 2015

Related U.S. Application Data
(60) Provisional application No. 61/981,399, filed on Apr. 18, 2014.

(51) Int. Cl. G06Q 30/06

(52) U.S. Cl. CPC G06Q 30/0633

(57) ABSTRACT

A system for remote shopping, includes an application, the application including functionality for a user to select goods to be purchased from a retail store, the application being adapted to communication with a store system for providing information regarding the selected goods to be purchased, and to receive from the store system a price for the selected goods, the application further being configured and arranged to provide to the user information regarding the goods selected including an order status and a total price, wherein the total price reflects a same price that would be received if the same goods were to be purchased in-store.

### CROSS-REFERENCE TO RELATED APPLICATION

This application claims priority to U.S. Provisional Application No. 61/981,399, filed on Apr. 18, 2014, entitled “System and Method for Remote Shopping,” the contents of which are hereby incorporated herein by reference in their entirety.

### FIELD

Embodiments herein generally relate to systems and methods for providing shopping services in a retail environment.

### BACKGROUND

Grocery services exist in which customers may remotely select items for their order via a webpage for later pickup or delivery. Typically, such services do not interact directly with in-store information systems. In a retail operation, and in particular in a grocery retail operation, certain items are sold by weight and are sold loose, so that for any particular collection of items for purchase, there is not a price that can be determined prior to the shopper making a selection. Remote shopping systems may have difficulty providing actual pricing for such items that are sold by weight, or for items that have in-store special pricing such as manager's specials.

### BRIEF DESCRIPTION OF THE FIGURES

FIG. 1 schematically illustrates a remotely accessible system for use in a retail environment in accordance with an embodiment;

FIG. 2 schematically illustrates a remotely accessible system for use in a retail environment in accordance with another embodiment;

FIG. 3 illustrates a user interface for use in a remotely accessible system for use in a retail environment in accordance with an embodiment; and

FIG. 4 schematically illustrates an embodiment of a system architecture for use in embodiments of the remotely accessible retail system,

### DETAILED DESCRIPTION

In an embodiment, a remotely accessible system for use in a retail environment includes functionality for shopping and selecting items for purchase. Such a system may be implemented, for example, as an application for a mobile device or as a web client application. As an example, the application may be operable on the iOS, Android, or Windows Mobile platforms.

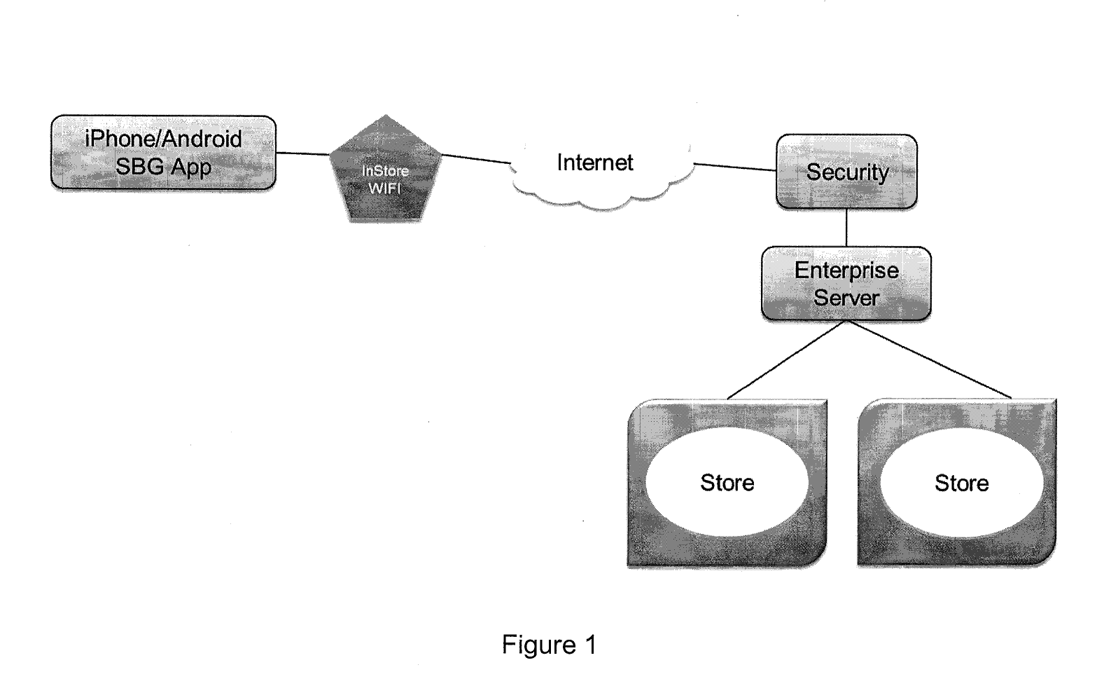

In an embodiment, the application communicates via the Internet with a server side device as shown in FIG. 1. In the illustrated embodiment, a security module, which may be a firewall, a secure server, and/or other network security component receives communications from the application via the Internet. Where the communication is authenticated (for example, using secure HTTP or other secure communications protocols, it is passed to the enterprise server. The enterprise server, in turn, communicates with a selected in-store system, each representing a particular store in a chain of stores, for example.

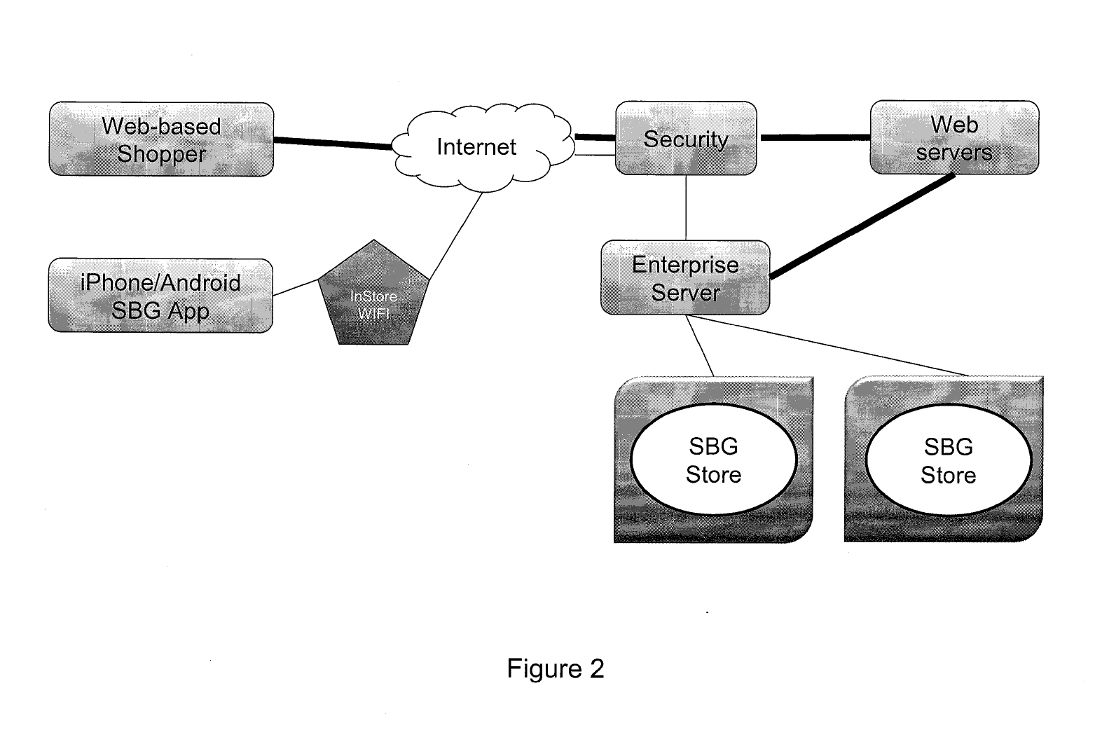

In another embodiment, shown in FIG. 2, a web server may be included in the network such that the application, either accessed by a user via a web client or via a mobile app, passes through the web server. By way of example, this approach may involve a user accessing retailer_name.com in order to interact with the system. This access may be via a web browser or an app. In an embodiment, the app may interface by way of a mobile communications link, or by wi-fi (including in-store wi-fi) and from there to an Internet connection.

By way of example, the mobile application may interact with the store system using data in a JSON format which is passed via a REST transfer architecture. The enterprise server then communicates with the local store software.

In an embodiment, the store system may include functionality that allows shoppers to shopping using a mobile device that may be handheld and/or associated with a shopping cart. Examples of such mobile devices are described, for example, in U.S. patent application Ser. No. 13/490,174, herein incorporated by reference. The mobile device may, for example, incorporate a reader, a display, a memory and a user interface. The mobile device may be detachably or permanently connected to a shopping cart, or may be borne by the cart operator, for example on a belt clip or the like. The mobile device and its user interface may operate as the display of the cart mentioned above with respect to the scale, or may alternately communicate with a separate display of the cart to provide an alternate viewing area for the user. In principle, the device may be a store-specific device or may be, for example, a mobile phone running an application that allows it to interface with the store infrastructure. Embodiments may include the ability for a user's device to interface with the store-supplied mobile device, via the communication network.

Embodiments of the mobile device include wireless communication functionality so that the mobile device may communicate with a store network. The mobile device may communicate using one or more of a number of common protocols including but not limited to BLUETOOTH (IEEE 802.15.1 and 802.15.2), WIMEDIA (IEEE 802.15.3), WI-FI (IEEE 802.11b), Wi-Fi5 (IEEE 802.11a/HL2) and other wireless protocols like protocol 802.15.4 (ZIGBEE). The store network may include functionalities for associate task management, shopper self-checkout, video or location based analytics, price lookup, loss management, and others.

In some embodiments, the store network may include one or more of a star network, a multi-network, mesh network, and wireless and/or wired communication lines joining each of the several nodes to a server. In some embodiments, each node may include one or more radios or wired links to communicate with others of the nodes and/or the server. Examples of store networks that may be suited to incorporation with embodiments may be found in U.S. Pat. No. 7,672,876, herein incorporated by reference.

In an embodiment, the application receives pricing information directly from the in-store POS by way of the store network. Because the in-store POS system is accessible, actual, current pricing is available to the remote shopping application. That is, in this embodiment, the pricing for each product provided to the remote shopping application is exactly the same pricing that would be provided if that product were to be rung up at a register within the store. In this regard, weekly specials, manager's in-store specials, and other temporary or alternative pricing is available to the remote shopper just as it is available to the in-store shopper.

In an embodiment, the store network involved in the pricing and picking system is the same network as is employed by an in-store network of handheld devices, and is separate from the in-store wi-fi network. By way of example, the handheld device network that provides service for self-checkout, associate task management, and other services may be a Zigbee network while the store wi-fi network is used separately to provide Internet access for other services.

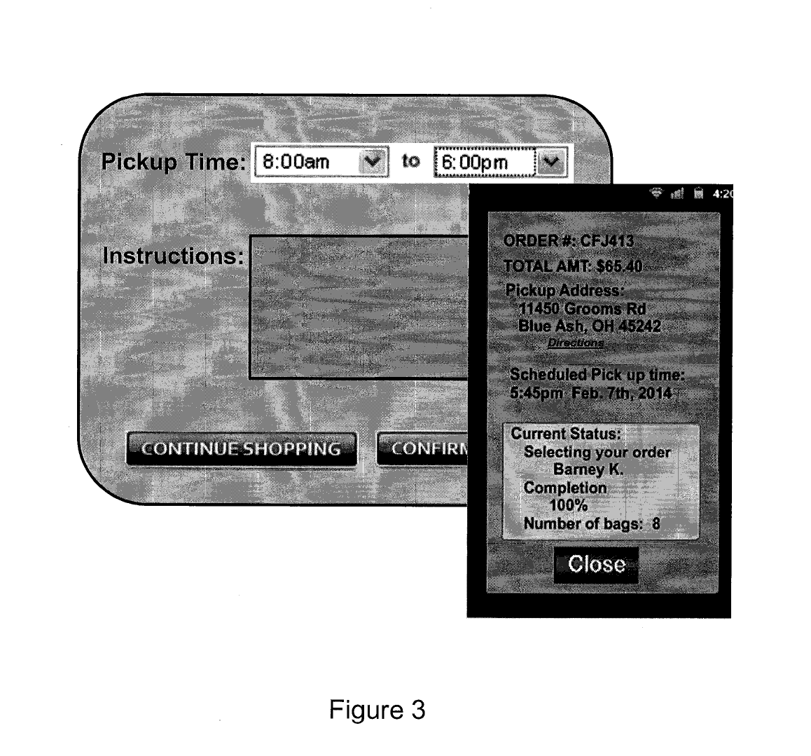

In an embodiment, the system includes functionality for providing status to a user as illustrated in FIG. 3. The user may see the pick progress as well as the assigned store associate's name, and a total number of bags that the order has generated. Additionally, indications of the order number and pickup address are optionally provided. The application may also provide collateral information such as a savings amount, relevant advertising or coupons, and total price.

The total price may be updated in real time as the associate performs the pick. For example, where an item is sold by weight, it may not be possible, in advance, to inform the user of the exact price. If, for example, onions are priced at $0.99/lb., a user may request two onions, assuming that they will weigh slightly more than one pound total. When the associate makes the actual pick and weighs the onions, the order will update to indicate, for example, 1.2 lbs., and a price of $1.19. The updated order total may be relayed to the remote application, again in real time, or in periodic batch updates.

In an embodiment, once the order is 100% picked, the customer may be given an opportunity to provide final approval/confirmation of pick-up time and/or to provide any pick-up instructions.

In one implementation, the system may automatically arrange the pick list for the associate in an order associated with the store layout. Again, the store management system may be queried to provide the system with actual current location of goods. In particular, this may be useful where the planogram is variable, where specials are placed on endcaps temporarily for promotional purposes, or where seasonal items are involved.

In an embodiment, the system may include a printing function allowing labels to be printed for identifying orders (e.g., by order number and/or customer name) and for indicating a number of bags in the order and/or an identifier for each bag (e.g., 1 of 3).

As the associate performs the pick, he or she may make use of a handheld scanner (mobile device) as described above. The associate mobile device may be used to scan identifying information on items to be purchased or under consideration, for example a bar code. As will be appreciated, other machine readable identifying codes may be used in place of bar codes. Machine readable media in certain embodiments may also able to be read and understood by humans in addition to being able to be read by machines. Examples of a machine readable medium include, but should not be limited to, bar codes in the form of Universal Product Codes (UPC), Radio Frequency Identification (RFID) tags, produce lookup codes (PLU), including double stack PLUs, and Electronic Product Codes (EPC) tags.

For items sold by weight, the associate may use a scale to weigh one or more items. The scale may then provide a machine readable code or user enterable code to encode the item's weight and price.

In an embodiment, the associate's handheld provides a display that indicates the next item on the list as well as a store location for that item.

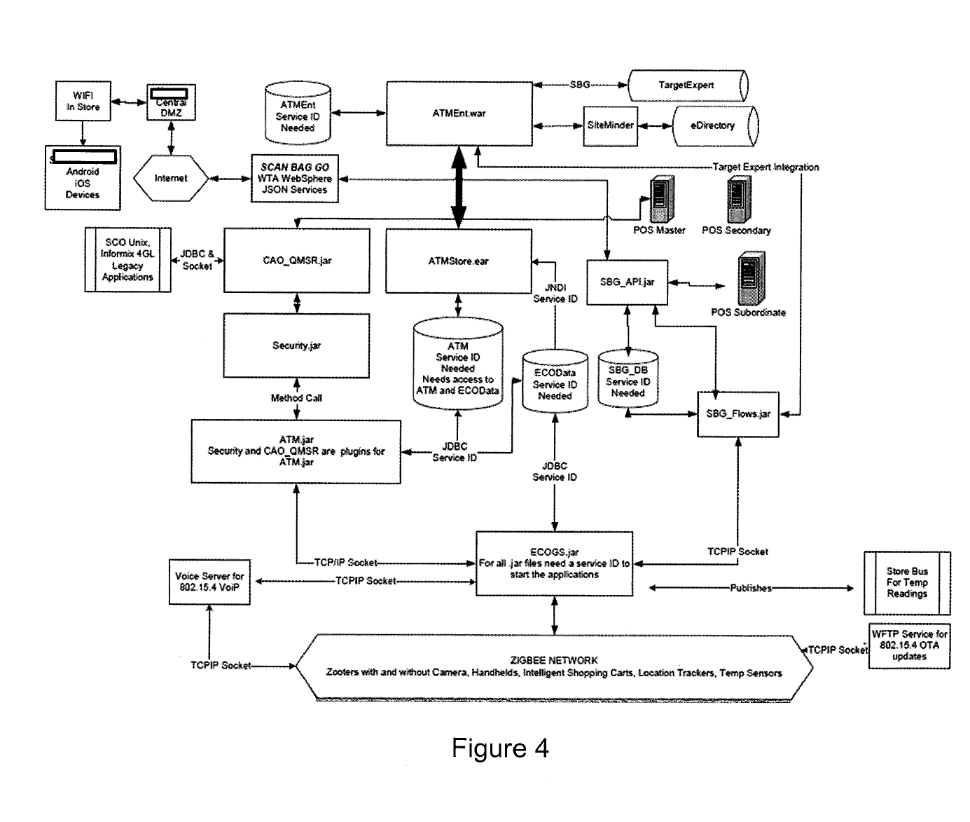

FIG. 4 illustrates a particular system architecture for an implementation of the foregoing described system.

While in the foregoing specification this invention has been described in relation to certain particular embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that, structural features or method steps shown or described in any one embodiment herein can be used in other embodiments as well.

What is claimed is:

1. A system for remote shopping, comprising:
an application, the application including functionality for a user to select goods to be purchased from a retail store, the application being adapted to communication with a store system for providing information regarding the selected goods to be purchased, and to receive from the store system a price for the selected goods;
the application further being configured and arranged to provide to the user information regarding the goods selected including an order status and a total price, wherein the total price reflects a same price that would be received if the same goods were to be purchased in-store.
